(19) United States
(12) Patent Application Publication
(10) Pub. No.: US 2021/0125127 A1
(43) Pub. Date: Apr. 29, 2021

(54) COMMUNITY DIVISION QUALITY EVALUATION METHOD AND SYSTEM BASED ON AVERAGE MUTUAL INFORMATION

(71) Applicant: SOUTH CHINA UNIVERSITY OF TECHNOLOGY, Guangzhou, Guangdong Province (CN)

(72) Inventors: Dong LI, Guangzhou (CN); Mingquan CHENG, Guangzhou (CN)

(21) Appl. No.: 17/041,747

(22) PCT Filed: Oct. 25, 2018
(86) PCT No.: PCT/CN2018/111945

§ 371 Date: Sep. 25, 2020

(30) Foreign Application Priority Data
Mar. 28, 2018 (CN) 201810263538.X

(51) Int. Cl. G06Q 10/06; G06Q 10/04; G06F 16/901

(52) U.S. Cl. CPC G06Q 10/06315; G06F 16/9024; G06Q 10/06395; G06Q 10/04

(57) ABSTRACT

The present invention discloses a community division quality evaluation method based on average mutual information and system thereof. Based on the classic GN community division system, the embodiment of the present invention adds a community division quality evaluation method based on average mutual information, first select the optimal community division corresponding to the largest average mutual information by calculating the average mutual information value of each community division, then calculate separately the information entropy of the community structure before and after the optimal community division to determine the optimal community structure, then traverse all nodes in the optimized community structure, find the node with the same number of links to multiple communities, and finally calculate the total information entropy of the network when the node is placed in different communities, and output the community structure corresponding to the smallest value of the total information entropy as the optimal community structure, effectively improves the accuracy of community division results.

### TECHNICAL FIELD

The invention relates to the field of community division quality evaluation, in particular to a community division quality evaluation method based on average mutual information and system thereof.

### TECHNICAL BACKGROUND

With the rapid development of the Internet and the Internet of Things technology, the connections between things have become closer, and intricate connections have formed a diverse, frequent-changing, and large-scale network. Such a network is called a complex network. The so-called community refers to a collection of related individuals, and a complex network is composed of several communities. Community division relates to multiple disciplines such as computing, physics, biology, sociology, and complexity systems science etc., and has become one of the research hotspots of many disciplines in recent years. In community division, the community division system usually constructs and evaluates a variety of community structures, and evolves from one community structure to another. The key to optimizing a community division system is to find a community division quality evaluation method, through which the community division system is optimized, thereby improving the accuracy of the community division system. However, the current thinking on the quality evaluation method of community division mainly focuses on modularity evaluation methods, and the modularity evaluation methods have the problem of resolution limit. Although there are also community division quality evaluation methods based on relevant knowledge of information theory, some prior conditions need to be known when using evaluation methods based on information theory.

### SUMMARY OF THE INVENTION

The purpose of the present invention is to address the deficiencies of the prior art and provide a community division quality evaluation method based on average mutual information. The method addresses existing classic community division systems. Starting from the perspective of community division quality evaluation, based on average mutual information, this evaluation method can be used to find the optimal community division from multiple community division candidate solutions without prior conditions, which effectively improves the accuracy of community division results. At the same time, the invention also discloses a community division quality evaluation system based on average mutual information.

The specific technical solutions of the present invention are: a community division quality evaluation method based on average mutual information, the method comprising the following steps:

S1. a server receives a community division request;
S2. using a betweenness algorithm to perform a betweenness calculation on the community division request to obtain a betweenness calculation result;
S3. based on the betweenness calculation result, delete an edge with a largest betweenness number to obtain community division results before and after the edge deletion; the server checks whether a community after the edge deletion has split, if yes, proceed to step S4, if not, then return to step S2 to re-perform the betweenness calculation on the community after the edge deletion according to the community division request;
S4. calculating an average mutual information value for all the community division results obtained in step S3 before and after the edge deletion to obtain a mutual information result; the server checks whether a current mutual information result after the edge deletion is a largest mutual information result, and if yes, modify the largest mutual information result and record a community structure before and after a community division corresponding to the largest mutual information result, and then proceed to step S5, if not, proceed directly to step S5;
S5. judging whether there is still an edge in a current community, if yes, return to step S2 to re-perform the betweenness calculation on the community after the edge deletion according to the community division request, if not, proceed to step S6;
S6. determining whether an information entropy of the largest mutual information result corresponding to the community structure before the community division in step S4 is greater than an information entropy of the largest mutual information result corresponding to the community structure after the community division, if not, record the largest mutual information result corresponding to the community structure before the community division as the community division results, if yes, record the largest mutual information result corresponding to the community structure after the community division as the community division results;
S7. according to the community division results in step S6, using a node with a same number of links to multiple communities to further optimize the community division results, and obtain a final community division result;
S8. sending the final community division result to a client.

Further, a specific operation of using a betweenness algorithm to calculate a betweenness of the community division request to obtain a betweenness calculation result of step S2 is: performing a shortest path calculation on the community division request to obtain the betweenness calculation result.

Further, a specific process of step S3 is: first sorting the betweenness from largest to smallest, deleting an edge with the largest betweenness, then saving results before and after the deletion into the community division results.

Further, a calculation formula of the average mutual information value of the community division results before and after the edge deletion in step S4 is: QI=E[I(Xᵢ;Yⱼ)]=Σᵢ Σⱼ P(Xᵢ,Yⱼ) I(Xᵢ;Yⱼ), where X, represents the i-th community before the community division, Yⱼ represents the j-th community after the community division, and QI is the average mutual information value.

Further, a calculation formula of the information entropy value in step S6 is: H(X)=−Σₓ(P(x=1)log₂ P(x=1)+P(x=0)log₂ P(x=0)), where P(x=1) represents a probability that a node is divided into community x, and P(x=0) represents a probability that the node is not divided into community x, H(X) is the information entropy value.

Further, a specific process of step S7 is: first finding a node connected to the multiple communities, then putting the node into multiple connected communities respectively, calculating separately a total information entropy of a network when the node is placed in different communities, a community structure corresponding to a smallest output of the total information entropy is a final community division result.

At the same time, the present invention discloses a system for realizing the above community division quality evaluation method based on average mutual information, characterized in that, the system comprises a client and a server, wherein the server comprises the following modules:
a request receiving module: used to receive community division requests sent by the client;
a betweenness calculation module: used to calculate betweenness and obtain the betweenness calculation result;
a betweenness deletion module: used to delete an edge with the largest betweenness according to the betweenness calculation result, and obtain the community division results before and after the betweenness is deleted;
an average mutual information value calculation module: used to calculate the average mutual information value to obtain the mutual information result;
an information entropy value calculation module: used to calculate the information entropy value before and after the division, and obtain the community division results with the smallest information entropy value;
an optimization module: according to the community division results, using the node with a same number of links to multiple communities to further optimize the community division result, obtaining the final community division result;
an output module: used to send the final community division result to the client.

Compared with the prior art, the present invention has the following advantages and beneficial effects:

1. The present invention introduces a community division quality evaluation method based on average mutual information in a community division system. The evaluation method calculates the average mutual information value of the community division during each community division process, finds out the community division corresponding to the largest average mutual information, further compares the information entropy of the community structure before and after the community division corresponding to the largest average mutual information, obtains the community division structure with the smallest information entropy, and finally uses a node with the same number of links to multiple communities to further optimize the community division results, to obtain the final community division result, thereby achieving the purpose of improving the accuracy of the community division result.
2. The present invention adopts a community division quality evaluation method based on average mutual information. Compared with other evaluation methods based on information theory, this evaluation method can be used without prior conditions.

### BRIEF DESCRIPTION OF THE FIGURES

FIG. 1 is a flowchart of a method for evaluating the quality of community division based on average mutual information according to an embodiment of the present invention.

FIG. 2(a) is an exemplary diagram of the community in an embodiment of the present invention without splitting. FIG. 2(b) is an exemplary diagram of the community split into two other communities in an embodiment of the present invention.

FIG. 3 is an exemplary diagram of a node with the same number of links to multiple communities in an embodiment of the present invention.

### DESCRIPTION

The present invention is further described in detail below in conjunction with embodiments and figures, but the embodiments of the present invention are not limited thereto.

### Embodiments

Based on the classic GN community division system, the embodiment of the present invention adds a community division quality evaluation method based on average mutual information. A community division quality evaluation method based on average mutual information is the core content of the present invention. After adding the community division quality evaluation method based on average mutual information, the community division system first selects the optimal community division corresponding to the largest average mutual information by calculating the average mutual information value of each community division, then calculates separately the information entropy of the community structure before and after the optimal community division to determine the optimal community structure, then traverses all nodes in the optimized community structure, finds the node with the same number of links to multiple communities, and finally calculates the total information entropy of the network when the node is placed in different communities, and outputs the community structure corresponding to the smallest value of the total information entropy as the optimal community structure.

The embodiment of the present invention additionally provides a community division quality evaluation system based on average mutual information. The system comprises a client and a server, wherein the server comprises the following modules: a request receiving module: used to receive community division requests sent by the client; a betweenness calculation module: used to calculate betweenness and obtain the betweenness calculation result; a betweenness deletion module: used to delete an edge with the largest betweenness according to the betweenness calculation result, and obtain the community division results before and after the betweenness is deleted; an average mutual information value calculation module: used to calculate the average mutual information value to obtain the mutual information result; an information entropy value calculation module: used to calculate the information entropy value before and after the division, and obtain the community division results with the smallest information entropy value; an optimization module: according to the community division results, using the node with a same number of links to multiple communities to further optimize the community division result, obtaining the final community division result; an output module: used to send the final community division result to the client.

The method and system for evaluating the community division quality based on average mutual information provided by the embodiments of the present invention are described in detail below.

First, for the relevant technical terms involved in the method and system provided by the embodiments of the present invention, we provide the following definitions, and combine the definitions to explain the basic principles of the present invention:

Definition 1: The community structure X represents the community structure before the a community division, and Xᵢ represents the i-th community in the community structure X. The community structure Y represents the community structure after a community division, and Yⱼ represents the j-th community in the community structure Y. nₓᵢ represents the total number of nodes in the community Xᵢ, n_{yj} represents the total number of nodes in the community Yⱼ, and n represents the total number of nodes in the network.

Definition 2: (average mutual information) Average mutual information is a measure of the amount of information that a random variable contains in another random variable. For two random variables X and Y, their joint probability density function is P(x,y), and their marginal probability density functions are P(x) and P(y) respectively. The average mutual information I(X;Y) is the relative entropy between the joint distribution P(x,y) and the multiplicative distribution P(x) P(y), and its calculation formula is as follows:

I(X;Y)=ΣₓΣ_{y}P(x,y)log₂[P(x,y)/(P(x)*P(y))] (1)

Definition 3: (information entropy) Information entropy is a concept used to measure the amount of information in information theory. H(X) represents information entropy, P(x) represents a probability density function, and the calculation formula of information entropy is as follows:

H(X)=ΣₓP(x)log₂P(x) (2)

Definition 4: (betweenness) Betweenness is defined as the ratio of the number of paths passing through an edge among all the shortest paths in a network to the total number of shortest paths. The greater the betweenness, the greater the probability that this edge will serve as a connecting edge between communities, so the goal of separating communities can be achieved by continuously deleting the edge with the largest betweenness.

Definition 5: (average mutual information of community division) For each community division, average mutual information means that the community structure Y after this community division includes a measure of the amount of information of the community structure X before this community division. According to the additivity of average mutual information, we further approximate the average mutual information value of the two community structures to the weight sum of the average mutual information value between the communities in the two community structures. The specific calculation formula is as follows:

QI=E[I(Xᵢ;Yⱼ)]=ΣᵢΣⱼP(Xᵢ,Yⱼ)I(Xᵢ;Yⱼ) (3)

where I(Xᵢ;Yⱼ) represents the average mutual information value of the community Xᵢ and the community Yⱼ, P(Xᵢ,Yⱼ)=P(Yⱼ|Xᵢ)×P(Xᵢ), P(Yⱼ|Xᵢ) represents the probability that a point in the community Xᵢ is divided into the community Yⱼ, P(Xᵢ) represents the probability that a point in the network is divided into the community Xᵢ.

Definition 6: (two situations of community division) Because the classic GN community division system is based on a split community division system, therefore, for the classic GN community division system, only the following two situations need to be considered:

1. In the community division, a certain community did not split;
2. In the community division, a certain community is split into two other communities.

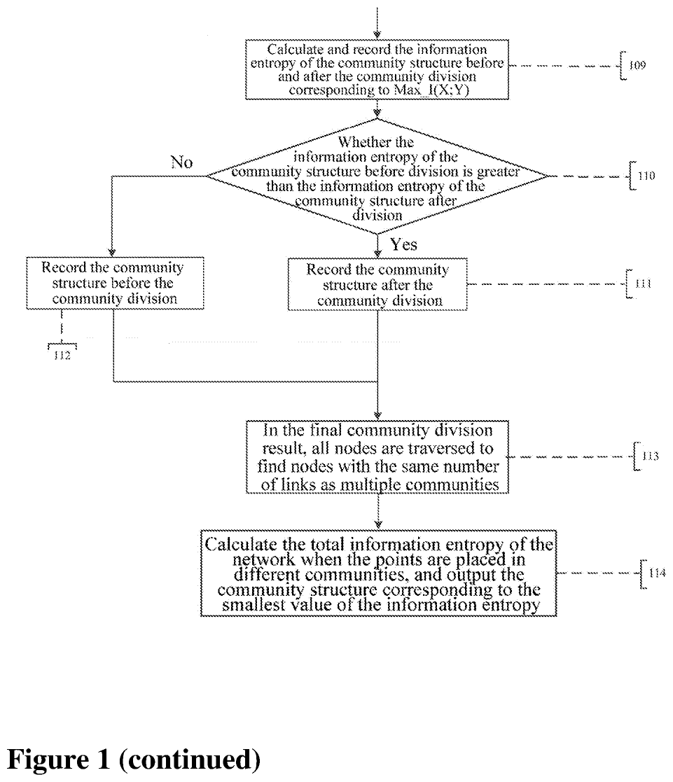

FIG. 2(a) and FIG. 2(b) are examples of two situations that occur in community division.

Therefore, for the above two cases, P(Yⱼ|Xᵢ) is calculated separately.

For the first case:

$$P ( {Y}_{j} \vert {X}_{i} ) = \{ \begin{matrix}1 & when {Y}_{j} and {X}_{i} are the same community \\ 0 & when {Y}_{j} and {X}_{i} are different communities \end{matrix} \qquad ( 4 )$$

For the second case:

$$P ( {Y}_{j} \vert {X}_{i} ) = \{ \begin{matrix}\frac{{n}_{y j}}{{n}_{xi}} & when {Y}_{j} is obtained by splitting community {X}_{i} \\ 0 & when {Y}_{j} is not obtained by splitting community {X}_{i}\end{matrix} \qquad ( 5 )$$

where nₓᵢ represents the total number of nodes in the community Xᵢ, and n_{yj} represents the total number of nodes in the community Yᵢ.

Definition 7: P(Xᵢ) represents the probability that a point in the network is divided into the community Xᵢ, so the calculation formula of P(Xᵢ) is as follows:

P(Xᵢ)=nₓᵢ/n (6)

Definition 8: p(Xᵢ=0) represents the probability that the node does not belong to the community Xᵢ, p(Xᵢ=1) represents the probability that the node belongs to the community Xᵢ, the calculation formula is as follows:

p(Xᵢ=0)=(n−nₓᵢ)/n (7)

p(Xᵢ=1)=nₓᵢ/n (8)

Definition 9: p(Yⱼ=1|Xᵢ=1) represents the probability that the node also belongs to the community Yⱼ under the condition that the node belongs to the community Xᵢ, then the calculation formula of p(Yⱼ=1|Xᵢ=1) is as follows:

p(Yⱼ=1|Xᵢ=1)=n_{yj}/nₓᵢ (9)

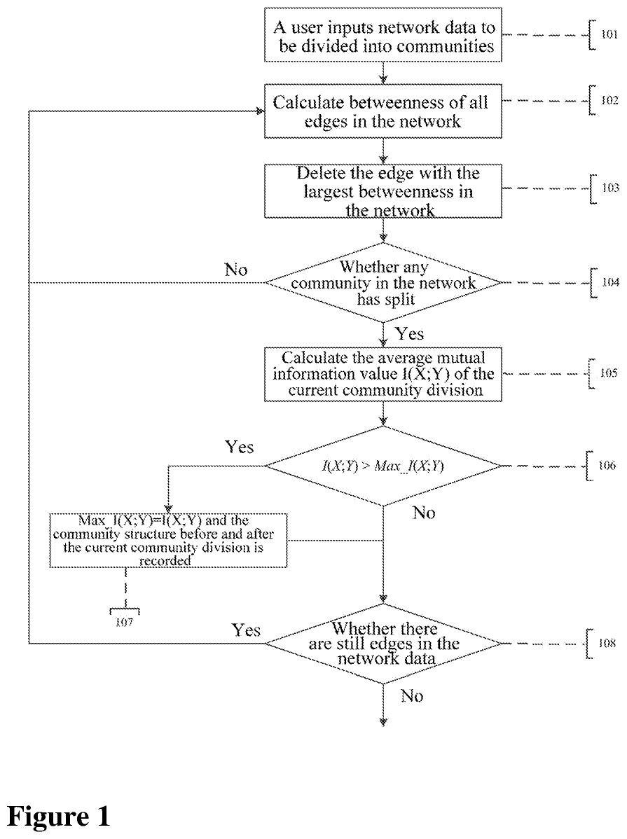

The flowchart of a community division quality evaluation method based on average mutual information provided by this embodiment is shown in FIG. 1, and specifically comprises the following steps:

Step 101: A user inputs network data to be divided into communities in the form of points and edges.

The input network data format is to enter two numbers for each line, separated by a space, and the two numbers represent two nodes respectively. For example, “1 2” means that there is a link between node 1 and node 2.

Step 102: Calculate betweenness of all edges in the network. For the definition of betweenness, see Definition 4.

The algorithm for calculating betweenness is as follows:

CalEdgeBetweeness Algorithm:

Input: the adjacency matrix E in the network

Output: betweenness of edge AB

| | |
|---|---|
| (1) | Initialize a two-dimensional dynamic matrix shortPath |
| (2) | Calculate all shortest paths in the network and store all the shortest paths in shortPath |
| (3) | FOR (i in shortPath) DO: |
| (4) | FOR (edge in shortPath[i]) DO: |
| (5) | IF AB and edge are the same edge |
| (6) | edgeNumber++; //edgeNumber represents the number of the shortest path through the edge |
| (7) | Break; |
| (8) | END IF |
| (9) | END FOR |
| (10) | ABEdgeBetweeness=(double) edgeNumber / shortPath.size(); |
| (11) | Output(ABEdgeBetweeness) |

The algorithm for calculating the shortest path in the network is as follows:

Input: the weightless adjacency matrix E in the network

Output: distance matrix D containing the shortest path length

| | |
|---|---|
| (1) | D <- E |
| (2) | FOR k = 1 to n DO: |
| (3) | FOR i = 1 to n DO: |
| (4) | FOR j = 1 to n DO: |
| (5) | D[i,j] = min{D[i,j], D[i,k] + D[k,j]} |
| (6) | END FOR |
| (7) | END FOR |
| (8) | END FOR |
| (9) | Output(D) |

Step 103: Delete the edge with the largest betweenness in the network.

In this step, after deleting an edge in the network, the total number of shortest paths in the network will also change, so the betweenness of the remaining edges needs to be recalculated next.

Step 104: Whether any community in the network has split. In the classic GN community division system, if a community has split, only then step 105 is started, or jump back to 102.

Step 105: Calculate the average mutual information value I(X;Y) of the current community division. The average mutual information is defined in Definition 2. The calculation formula of I(X;Y) is: I(X;Y)=Σᵢ Σⱼ P(Xᵢ,Yⱼ) I(Xᵢ;Yⱼ), where I(Xᵢ;Yⱼ)=ΣₐΣ_{b}P(Xᵢ=a,Yⱼ=b)[log₂ P(Xᵢ=a,Yⱼ=b)−(log₂ P(Xᵢ=a)+log₂ P(Yⱼ=b))]. As shown in FIG. 2(a) and FIG. 2(b), when calculating the average mutual information, two situations need to be considered for each community division: 1) In the community division, a certain community does not split. 2) In the community division, a certain community is split into two other communities. The algorithm for calculating I(X;Y) is as follows:

CalAverageMutualInformation Algorithm:

Input: a previous community division result X and a current community division result Y

Output: the value of I(X;Y)

| | |
|---|---|
| (12) | FOR i = 1 to clubNum DO: //clubNum indicates the number of communities |
| (13) | IF in the current community division, community i has split THEN |
| (14) | IF nodes in community i belong to neither the Xᵢ community nor the Yᵢ community THEN |
| (15) | //maxnum represents the total number of nodes in the network, last[i] represents the total number |
| | of nodes in community i in the result of the previous community division, now[i] represents the |
| | total number of nodes in community i in the result of the current community division |
| (16) | P(Xᵢ = 0) = (double)(maxnum − last[i]) / maxnum; |
| (17) | P(Yᵢ = 0) = (double)(maxnum − now [i]) / maxnum; |
| (18) | P(Xᵢ = 0,Yᵢ = 0) = P(Xᵢ = 0); |
| (19) | I(Xᵢ;Yᵢ) += P(Xᵢ = 0, Yᵢ = 0) * (log₂P(Xᵢ = 0,Yᵢ = 0) − log₂P(Xᵢ = 0) −log₂P(Yᵢ = 0)); |
| (20) | END IF |
| (21) | IF nodes in community i belong to the Xᵢ community but not to the Yᵢ community THEN |
| (22) | P(Xᵢ = 1) = (double) last[i] / maxnum; |
| (23) | P(Yᵢ = 0) = (double)(maxnum − now[i]) / maxnum; |
| (24) | P(Xᵢ = 1,Yᵢ = 0) = (double)(last[i] − now[i]) / maxnum; |
| (25) | I(Xᵢ;Yᵢ) += P(Xᵢ = 1, Yᵢ = 0) * (log₂P(Xᵢ = 1,Yᵢ = 0) − log₂P(Xᵢ = 1) − log₂P(Yᵢ = 0)); |
| (26) | END IF |
| (27) | IF nodes in community i belong to both Xᵢ community and Yᵢ community THEN |
| (28) | P(Xᵢ = 1) = (double) last[i] / maxnum; |
| (29) | P(Yᵢ = 1) = (double) now[i] / maxnum; |
| (30) | P(Xᵢ = 1, Yᵢ = 1) = P(Yᵢ = 1); |
| (31) | I(Xᵢ;Yᵢ) += P(Xᵢ = 1, Yᵢ = 1) * (log₂P(Xᵢ = 1, Yᵢ = 1) − log₂P(Xᵢ = 1) − log₂P(Yᵢ = 1)); |
| (32) | END IF |
| (33) | I(X;Y) = I(X;Y) + I(Xᵢ;Yᵢ) * P(Xᵢ = 1, Yᵢ = 1); |
| (34) | ELSE IF in the current community division, community i did not split |
| (35) | IF nodes in community i belong to neither the Xᵢ community nor the Yᵢ community THEN |
| (36) | P(Xᵢ = 0) = (double)(maxnum − last[i]) / maxnum; |
| (37) | P(Yᵢ = 0) = (double)(maxnum − now[i]) / maxnum; |
| (38) | P(Xᵢ = 0, Yᵢ = 0) = P(Xᵢ = 0); |
| (39) | I(Xᵢ;Yᵢ) += P(Xᵢ = 0, Yᵢ = 0) * (log₂P(Xᵢ = 0, Yᵢ = 0) − log₂P(Xᵢ = 0) − log₂P(Yᵢ = 0)); |
| (40) | END IF |
| (41) | IF nodes in community i belong to both the Xᵢ community and the Yᵢ community THEN |
| (42) | P(Xᵢ = 1) = (double last[i] / maxnum; |
| (43) | P(Yᵢ = 1) = (double) now [i] / maxnum; |
| (44) | P(Xᵢ = 1, Yᵢ = 1) = P(Yᵢ = 1); |
| (45) | I(Xᵢ;Yᵢ) += P(Xᵢ = 1, Yᵢ = 1) * (log₂P(Xᵢ = 1, Yᵢ = 1) − log₂P(Xᵢ = 1) − log₂P(Yᵢ = 1)); |
| (46) | END IF |
| (47) | END IF |
| (48) | I(X;Y) = I(X;Y) + I(Xᵢ;Yᵢ) * P(Xᵢ = 1, Yᵢ = 1); |
| (49) | END FOR |
| (50) | Output(I(X;Y)) |

Step 106: Determine whether I(X;Y) is greater than the maximum value of I(X;Y). If it is greater than the maximum value of I(X;Y), only then step 107 is started; otherwise, directly perform step 108.

Step 107: The maximum value of I(X;Y) is equal to I(X;Y) and the community structure before and after the current community division is recorded, and proceed to step 108.

In this step, Max_I(X;Y) represents the maximum value of I(X;Y).

Step 108: Determine whether there are still edges in the network data. If there are edges, continue the community division, that is, return to step 102. If there are no edges to split, it means that the overall community division has ended, and then start step 109.

Step 109: Calculate and record the information entropy of the community structure before and after the community division corresponding to Max_I(X;Y). For the definition of information entropy, see Definition 3. The algorithm for calculating the information entropy H(X) is as follows:

CalInformationEntropy Algorithm:

Input: Community Structure X

Output: the value of H(X)

| | |
|---|---|
| (1) | FOR i = 1 to clubNum DO: |
| | //clubNum indicates the number of communities |
| (2) | P(Xᵢ = 1) = (double)shetuan[i] / maxnum; |
| | //shetuan[i] indicates the number of nodes in the i-th community |
| (3) | P(Xᵢ = 0) = (double)(maxnum − shetuan[i]) / maxnum; |
| (4) | H(Xᵢ) = −P(Xᵢ = 1) * log₂P(Xᵢ = 1) + (−P(Xᵢ = 0) * log₂P(Xᵢ = 0)) |
| (5) | H(X) += H(Xᵢ); |
| (6) | END FOR |
| (7) | Output(H(X)) |

Step 110: Determine whether the information entropy of the community structure before division is greater than the information entropy of the community structure after division. If the information entropy of the community structure before division is greater than the information entropy of the community structure after division, then step 111 is started, otherwise, perform step 112.

Step 111: Record the community structure after the community division.

This step is to record the community structure corresponding to the smallest information entropy. Because the smaller the information entropy, the smaller the uncertainty in the community structure, that is, the community structure is more stable.

Step 112: Record the community structure before the community division.

This step is to record the community structure corresponding to the smallest information entropy. Because the smaller the information entropy, the smaller the uncertainty in the community structure, that is, the community structure is more stable.

Step 113: In the final community division result, all nodes are traversed, and then nodes with the same number of links as multiple communities are found.

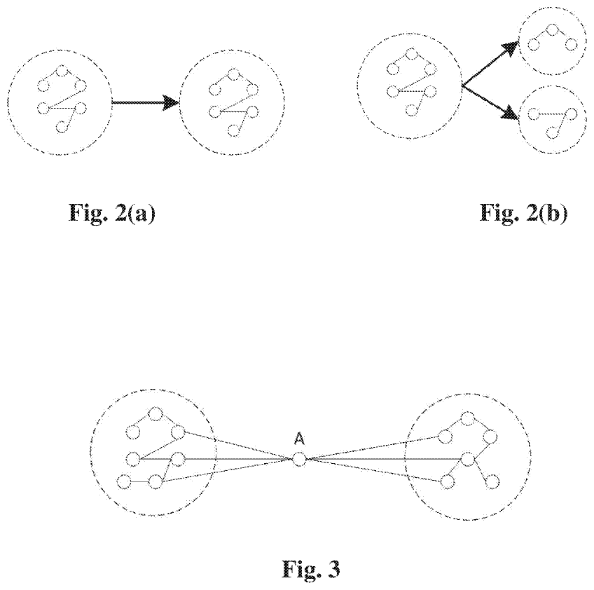

In this step, an example of a node with the same number of links to multiple communities is shown as node A in FIG. 3. The algorithm for finding a node with the same number of links to multiple communities is as follows:

SameLinkNumber Algorithm:

Input: the adjacency matrix E in the network

Output: Nodes with the same number of links to multiple communities

| | |
|---|---|
| (1) | Initialize a one-dimensional array Edge; |
| (2) | FOR i = 1 to nodeNumber DO: |
| | //nodeNumber indicates the total number of nodes in the network |
| (3) | FOR j = 1 to clubNum DO: |
| | //clubNum indicates the number of communities |
| (4) | FOR (node in j) DO: |
| (5) | Edge[j] = Edge[j] + E[i][node]; |
| (6) | END FOR |
| (7) | END FOR |
| (8) | IF Edge array has the same value THEN |
| (9) | Output(node i); |
| (10) | END FOR |

Step 114: Calculate the total information entropy of the network when points with the same number of links are placed in different communities, and output the community structure corresponding to the smallest value of the information entropy.

The algorithm for calculating the information entropy in this step can refer to CalInformationEntropy Algorithm in step 109.

In summary, the embodiments of the present invention are an improved community division system provided by a community division quality evaluation method and system based on average mutual information. The optimized community division system selects the optimal community division corresponding to the largest average mutual information by calculating the average mutual information value of each community division, and then the information entropy of the community structure before and after the optimal community division is calculated to determine the optimal community structure. This greatly improves the accuracy of the community division system, making the improved community division system a new community division system.

The above are only preferred embodiments of the patent of the present invention, but the scope of protection of the patent of the present invention is not limited to this. Equivalent replacements or changes made by a technical person familiar with this technical field within the scope disclosed in the patent of the present invention, based on the technical solutions of the patent of the present invention and the concept of this invention patent, all belong to the protection scope of the patent of the invention.

1. A community division quality evaluation method based on average mutual information, characterized in that the method comprises the following steps:
S1. receiving a community division request;
S2. using a betweenness algorithm to perform a betweenness calculation on the community division request to obtain a betweenness calculation result;
S3. based on the betweenness calculation result, deleting an edge with a largest betweenness number to obtain community division results before and after the edge deletion, then checking whether a community after the edge deletion has split, and if yes, proceeding to step S4, and if not, then returning to step S2 to re-perform the betweenness calculation on the community after the edge deletion according to the community division request;
S4. calculating an average mutual information value for all the community division results obtained in step S3 before and after the edge deletion to obtain a mutual information result, then checking whether a current mutual information result after the edge deletion is a largest mutual information result, and if yes, modifying the largest mutual information result and recording a community structure before and after a community division corresponding to the largest mutual information result, and then proceeding to step S5, and if not, proceeding directly to step S5;
S5. judging whether there is still an edge in a current community, and if yes, returning to step S2 to re-perform the betweenness calculation on the community after the edge deletion according to the community division request, and if not, proceed to step S6;
S6. determining whether an information entropy of the largest mutual information result corresponding to the community structure before the community division in step S4 is greater than an information entropy of the largest mutual information result corresponding to the community structure after the community division, and if not, recording the largest mutual information result corresponding to the community structure before the community division as the community division results, and if yes, recording the largest mutual information result corresponding to the community structure after the community division as the community division results;
S7. according to the community division results in step S6, using a node with a same number of links to multiple communities to further optimize the community division results and obtain a final community division result; and
S8. sending the final community division result to a client.

2. The community division quality evaluation method based on average mutual information according to claim 1, characterized in that, a specific operation of using a betweenness algorithm to calculate a betweenness of the community division request to obtain a betweenness calculation result of step S2 is: performing a shortest path calculation on the community division request to obtain the betweenness calculation result.

3. The community division quality evaluation method based on average mutual information according to claim 1, characterized in that, a specific process of step S3 is: first sorting the betweenness from largest to smallest, deleting an edge with the largest betweenness, then saving results before and after the deletion into the community division results.

4. The community division quality evaluation method based on average mutual information according to claim 1, characterized in that, a calculation formula of the average mutual information value of the community division results before and after the edge deletion in step S4 is: QI=E[I(Xᵢ;Yⱼ)]=Σᵢ Σⱼ P(Xᵢ,Yⱼ) I(Xᵢ;Yⱼ), where Xᵢ represents the i-th community before the community division, Yⱼ represents the j-th community after the community division, and QI is the average mutual information value.

5. The community division quality evaluation method based on average mutual information according to claim 1, characterized in that, a calculation formula of the information entropy value in step S6 is: H(X)=−Σₓ(P(x=1)log₂ P(x=1)+P(x=0)log₂ P(x=0)), where P(x=1) represents a probability that a node is divided into community x, and P(x=0) represents a probability that the node is not divided into community x, H(X) is the information entropy value.

6. The community division quality evaluation method based on average mutual information according to claim 1, characterized in that, a specific process of step S7 is: first finding a node connected to the multiple communities, then putting the node into multiple connected communities respectively, calculating separately a total information entropy of a network when the node is placed in different communities, a community structure corresponding to a smallest output of the total information entropy is a final community division result.

7. A system for realizing a community division quality evaluation based on average mutual information, characterized in that the system comprises a client and a server, wherein the server comprises the following modules:
a request receiving module used to receive community division requests sent by the client;
a betweenness calculation module used to calculate betweenness and obtain the betweenness calculation result;
a betweenness deletion module used to delete an edge with the largest betweenness according to the betweenness calculation result, and obtain the community division results before and after the betweenness is deleted;
an average mutual information value calculation module used to calculate the average mutual information value to obtain the mutual information result;
an information entropy value calculation module used to calculate the information entropy value before and after the division, and obtain the community division results with the smallest information entropy value;
an optimization module according to the community division results, using the node with a same number of links to multiple communities to further optimize the community division result, obtaining the final community division result;
an output module used to send the final community division result to the client.
